(19) United States
(12) Patent Application Publication
(10) Pub. No.: US 2012/0113458 A1
(43) Pub. Date: May 10, 2012

(54) MOBILE PRINTING FRAMEWORK

(75) Inventor: LASZLO CSABA BENEDEK, RICHMOND HILL (CA)

(73) Assignee: FLEXTRONICS ID, LLC, BROOMFIELD, CO (US)

(21) Appl. No.: 12/943,853

(22) Filed: Nov. 10, 2010

(51) Int. Cl. G06F 3/12

(52) U.S. Cl. 358/1.15

(57) ABSTRACT

A framework for printing files from a portable computing and telecommunication device to a nearby printer. The device includes a Print Service and a Printing System, with the Print Service communicating between an Application operating on the device and the Printing System. The Printing System communicates between the Print Service and the printer. The Printing System determines what printers are nearby and what driver is needed to communicate with that printer. The Printing System can then access the internet to obtain a printer driver if the Printing System does not already contain that printer driver.

### BACKGROUND

As computers become smaller and more portable, it has become desirable to have increased ability to print to different printers from a portable computer. For example, with handheld computers approaching the size of a mobile phone, these computers and their users may often be in the vicinity of a printer that the user would like to print to but cannot easily access. This may occur anytime the user is located away from their residence or typical workplace. One example may be the case of a user who has traveled to a different state to attend a conference and wishes to print to a printer at her hotel as well as to a printer at the conference center.

Current methods the user might be able to employ to print to one of these printers each have their own disadvantages. One method includes the user controlling the computer to place a file to be printed onto a removable memory card or other portable memory device (e.g., a USB flash drive) that can be removed from the computer and inserted into a second computer that is connected to the printer. The second computer then must be operated to print the file on the printer. A variation of this method includes certain printers and/or peripheral devices associated with printers that can directly receive the portable memory device. Either way, the overall method can be cumbersome and can result in the user forgetting to retrieve her memory device and re-insert it in her handheld computer. Another variation may include using a USB cable to pass the files from the handheld computer to the second computer. This may be similarly cumbersome.

A second method includes using communication protocols such as Bluetooth (or via a wireless router) to send the file to be printed from the handheld computer to the second computer and then operating the second computer to print the file on the printer. This method can also be cumbersome.

Another method that is gaining in popularity is known as cloud printing. This technique involves an application on a handheld computing device contacting an internet cloud print service that may be supplied by a vendor (e.g., Google). The cloud print service may then communicate via the internet with a second computer that sends the print job to the printer. The user must have already registered the printer with the cloud print service and additional software may be necessary for the second computer to speak with the cloud print service. Also the second computer needs to be on and connected to the printer for this method to work. In addition, these cloud print service vendors may charge a fee for access to their service.

Another method is to pre-load the appropriate printer driver onto the handheld computer and provide a communication link between the computer and the printer. While this method might work fairly well for a single printer, it would not work as well for a mobile user that may wish to print to various different additional printers each day. In such case, dozens or hundreds of printer drivers may be required. So the mobile user may need to go through a process regularly to load additional printer drivers, since there are so many different types of printers that each have their own unique printer driver. Further, many users may not be adept at obtaining and loading new printer drivers onto their handheld computers.

Lastly, there are printers in existence that have some amount of general purpose computing capability built in and these specialty printers can accept files in standard formats such as are used by word processing programs, image handling programs, and other applications typically used on a desktop or portable general purpose computer. These specialty printers can then convert these standard format files into print jobs which are then printed by the printer. Such specialty printers are not commonly found in use, and are not likely to be the printers that the hypothetical user looking to print on a nearby printer will encounter.

It is against this background that the present invention has been developed. The foregoing examples of the related art and limitations related therewith are intended to be illustrative and not exclusive. Other limitations of the related art will become apparent to those of skill in the art upon a reading of the specification and a study of the drawings.

### SUMMARY

The mobile printing framework includes a system for sending print jobs to an external printer from a mobile telecommunication and computing device that can access both a telephone network and the internet. The system includes one or more processors on the mobile telecommunication and computing device that contain at least the following processing modules thereon: an application that contains or generates a file to be printed; a print service that communicates with the application; and a printing system that communicates with the print service, with external printers, and with the internet, wherein the printing system obtains printer drivers by accessing the internet. Wherein, upon request by the print service, the printing system discovers a printer connected to a local network associated with a nearby wireless router, and further, the printing system determines if the printing system already contains the necessary printer driver to send print jobs to that printer and obtains that printer driver via the internet if it is not already contained in the printing system, and uses that printer driver to create a print job from the file to be printed, and then the print job is sent to the printer.

The print service may obtain the file to be printed from the application and supply it to the printing system. The print service may include a print API. The print service may control the printing system to perform the functions of printer discovery, obtaining printer details, selecting the printer driver, and installing the printer driver.

The mobile printing framework includes a method implemented in a mobile telecommunication and computing device for sending print jobs to an external printer. The method includes generating or obtaining a file to be printed; determining what local computer networks are located in the vicinity of the device; determining what type of printer is connected to that local network; determining whether a printer driver for that type of printer currently is loaded onto the device; if not currently loaded, obtaining the printer driver via the internet and loading it on the device; using the printer driver to convert the file to be printed into a print job; and sending the print job to the external printer via the local network.

The determining operations may each be performed by a printing system. The printing system may be controlled by a print service. The file to be printed may be sent to the printing system via a print API that is contained in the print service. The file to be printed is sent to the printing system via a print API.

### BRIEF DESCRIPTION OF THE DRAWINGS

FIG. 1 is a block diagram of a system for printing to a nearby computer from a portable device.

FIG. 2 is a block diagram of an exemplary embodiment of a portable computing device.

FIG. 3 is a block diagram of a Print Service and a Print System located in the portable device of the system of FIG. 1.

### DETAILED DESCRIPTION

The following description is not intended to limit the invention to the form disclosed herein. Consequently, variations and modifications commensurate with the following teachings, and skill and knowledge of the relevant art, are within the scope of the present invention. The embodiments described herein are further intended to explain modes known of practicing the invention and to enable others skilled in the art to utilize the invention in such, or other embodiments and with various modifications required by the particular application(s) or use(s) of the present invention.

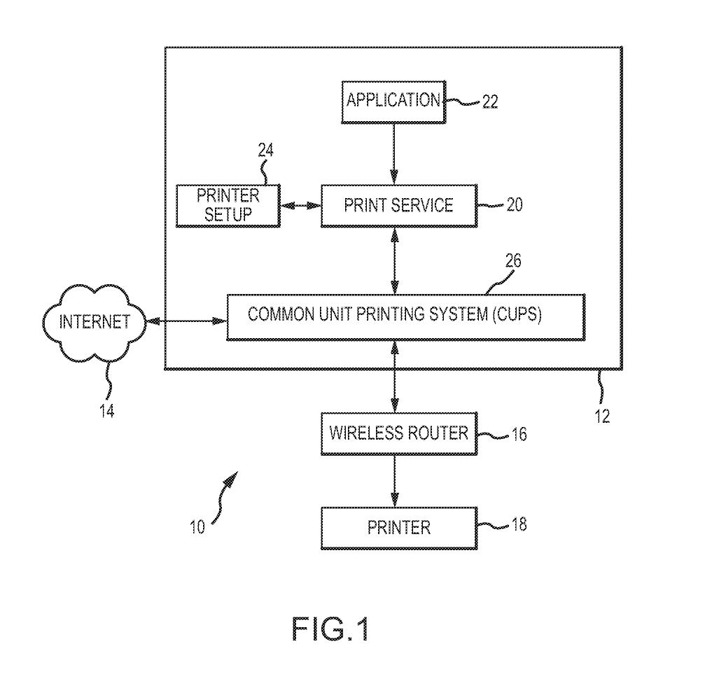

FIG. 1 shows a system 10 for printing documents that includes a portable or handheld telecommunication and computing device 12 that communicates with the internet 14 and sends print jobs through a wireless router 16 to a nearby printer 18. The printer 18 can be most any type of printer that can receive print jobs from a general purpose computer. At a minimum, such printers include most any laser or ink jet printer used by consumers and most businesses. The wireless router 16 can be any conventional wireless router that allows computing devices to communicate with a local area network via any of the IEEE 802.11 standards, or any other suitable communication protocol. Instead of a wireless router, any other suitable device that allows a nearby computing device to communicate with a printer could be used (e.g., any other type of network communication device). A print server (not shown) may also be a part of the connection to the printer 18.

The portable telecommunication and computing device 12 can be any suitable device that can connect to a device such as the wireless router 16 and can connect through some means to the internet 14, and from which a user seeks to send a file to be printed to a nearby printer. The device 12 can also have the capability to serve as a mobile phone by accessing telecommunication networks in a conventional fashion. It is anticipated that in the near future, the consumer market will be flooded with such devices. Current early generation examples include the Apple iPhone, and other similar devices available from Samsung, LG, Sony Ericsson, Motorola, HTC, and others. As will be discussed further below, some of these devices use the Android operating system developed by Google.

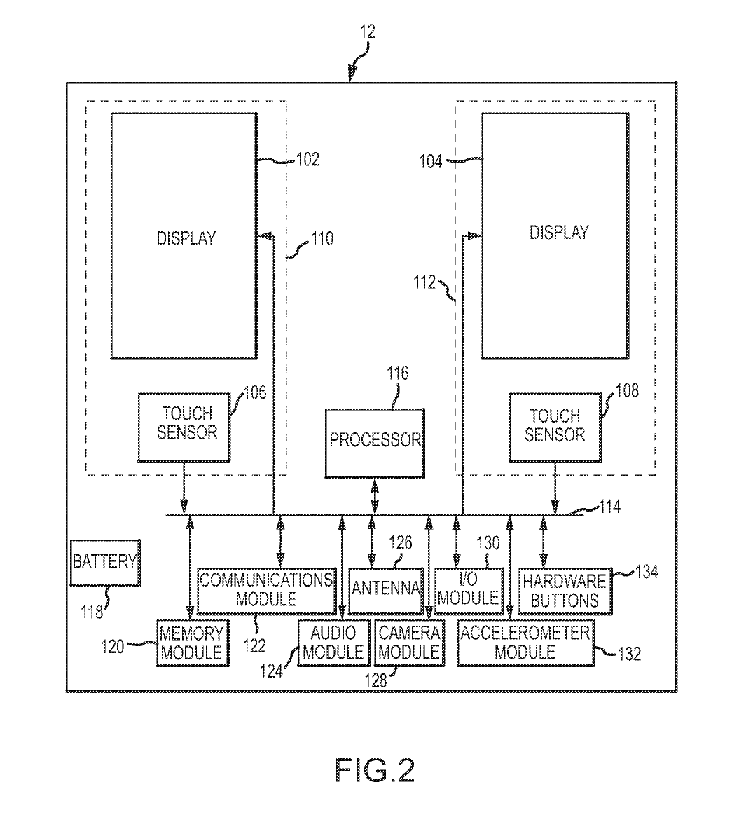

The device 12 is shown in more detail in FIG. 2. The handheld computing device 12 may include a first display 102 and a second display 104. Additionally, while two screens may be shown and described below with regard to the functionality of various embodiments of handheld computing devices, it will be understood that a handheld computing device may be provided that includes only one or more than two displays. In any regard, the first display 102 and the second display 104 may be independently controllable to display one or more GUIs. The GUIs may be associated with one or more applications or an operating system executing on the handheld computing device 12. In one embodiment, each display may have a resolution of 480 pixels by 800 pixels, although higher and lower resolution displays may also be provided.

The handheld computing device 12 may further include at least a first touch sensor 106. Furthermore, the handheld computing device may include a second touch sensor 108. The first touch sensor 106 and/or the second touch sensor 108 may be touchpad devices, touch screen devices, or other appropriate touch sensitive devices. Examples include capacitive touch sensitive panels, resistive touch sensitive panels, or devices employing other touch sensitive technologies. The first touch sensor 106 and/or second touch sensor 108 may be used in conjunction with a portion of a user's body (e.g., finger, thumb, hand, etc.), a stylus, or other acceptable touch sensitive interface mechanisms known in the art. Furthermore, the first touch sensor 106 and/or the second touch sensor 108 may be multi-touch devices capable of sensing multiple touches simultaneously.

The first touch sensor 106 may correspond to the first display 102 and the second touch sensor 108 may correspond to the second display 104. In one embodiment of the handheld computing device 100, the first display 102 and the first touch sensor 106 comprise a first touch screen display 110. In this regard, the first touch sensor 106 may be transparent or translucent and positioned with respect to the first display 102 such that a corresponding touch received at the first touch sensor 106 may be correlated to the first display 102 (e.g., to interact with a GUI presented thereon). Similarly, the second display 104 and the second touch sensor 108 may comprise a second touch screen display 112. In this regard, the second touch sensor 108 may be positioned with respect to the second display 104 such that a touch received at the second touch sensor 108 may be correlated to the second display 104 (e.g., to interact with a GUI presented thereon). Alternatively, the first touch sensor 106 and/or the second touch sensor 108 may be provided separately from the displays 102, 104. Furthermore, in an alternate embodiment, only a single touch sensor may be provided that allows for inputs to control both the first display 102 and the second display 104. The single touch sensor may also be provided separately or integrally with the displays.

In this regard, the first and second touch sensors 106, 108 may have the substantially same footprint as the displays 102, 104. Alternatively, the touch sensors 106, 108 may have a footprint including less of the entirety of the displays 102, 104. Further still, the touch sensors 106, 108 may include a footprint that extends beyond the displays 102, 104 such that at least a portion of the touch sensors 106, 108 are provided in non-overlapping relation with respect to the displays 102, 104. As discussed further below, the touch sensors 106, 108 may alternatively be provided in complete nonoverlapping relation such that the footprint of the touch sensors 106, 108 is completely different than the footprint of the displays 102, 104.

The handheld computing device 12 may further include a processor 116. The processor 116 may be in operative communication with a data bus 114. The processor 116 may generally be operative to control the functionality of the handheld device 12. The processor 116 may execute an operating system and be operative to execute applications. The processor 116 may be in communication with one or more additional components 120-134 of the handheld computing device 12 as will be described below For instance, the processor 116 may be in direct communication with one more of the additional components 120-134 or may communicate with the one or more additional components via the data bus 114. Furthermore, while the discussion below may describe the additional components 120-134 being in operative communication with the data bus 114, it will be understood that in alternative embodiments, any of the additional components 120-134 may be in direct operative communication with any of the other additional components 120-134. Furthermore, the processor 116 may be operative to independently control the first display 102 and the second display 104 and may be operative to receive input from the first touch sensor 106 and the second touch sensor 108.

The handheld computing device may include a battery 118 operative to provide power to the various devices of the handheld computing device 12. In this regard, the handheld computing device 12 may be portable.

The handheld computing device 12 may further include a memory module 120 in operative communication with the data bus 114. The memory module 120 may be operative to store data (e.g., application data). For instance, the memory 120 may store machine readable code executable by the processor to execute various functionalities of the device 12.

Additionally, a communications module 122 may be in operative communication with one or more components via the data bus 114. The communications module 122 may be operative to communicate over a cellular network, a Wi-Fi connection, a hardwired connection or other appropriate means of wired or wireless communication. The handheld computing device 12 may also include an antenna 126. The antenna 126 may be in operative communication with the communications module 122 to provide wireless communication capability to the communications module 122. Accordingly, the handheld computing device 12 may have telephony capability (i.e., the handheld computing device 12 may be a smartphone device).

An audio module 124 may also be provided in operative communication with the data bus 114. The audio module 124 may include a microphone and/or speakers. In this regard, the audio module 124 may be able to capture audio or produce sounds. Furthermore, the device 12 may include a camera module 128. The camera module 128 may be in operative communication with other components of the handheld computing device 12 to facilitate the capture and storage of images or video.

Additionally, the handheld computing device 12 may include an I/O module 130. The I/O module 130 may provide input and output features for the handheld computing device 12 such that the handheld computing device 12 may be connected via a connector or other device in order to provide syncing or other communications between the handheld computing device 12 and another device (e.g., a peripheral device, another computing device etc.).

The handheld computing device 12 may further include an accelerometer module 132. The accelerometer module 132 may be able to monitor the orientation of the handheld computing device 12 with respect to gravity. In this regard, the accelerometer module 132 may be provided to determine whether the handheld computing device 12 is substantially in a portrait orientation or landscape orientation. The accelerometer module 132 may further provide other control functionality by monitoring the orientation and/or movement of the handheld computing device 12.

The handheld computing device 12 may also include one or more hardware buttons 134. The hardware buttons 134 may be used to control various features of the handheld computing device 12. The hardware buttons 134 may have fixed functionality or may be contextual such that the specific function of the buttons changes during operation of the handheld computing device 12. Examples of such hardware buttons include, but are not limited to, volume control, a home screen button, an end button, a send button, a menu button, etc.

Although a great deal of specific details have been provided with regard to the handheld telecommunication and computing device 12, it should be understood that the mobile printing framework described herein could also be embodied in any other suitable handheld device, and that the invention is not limited to embodiments having one or more of the details of the handheld device 12 described herein.

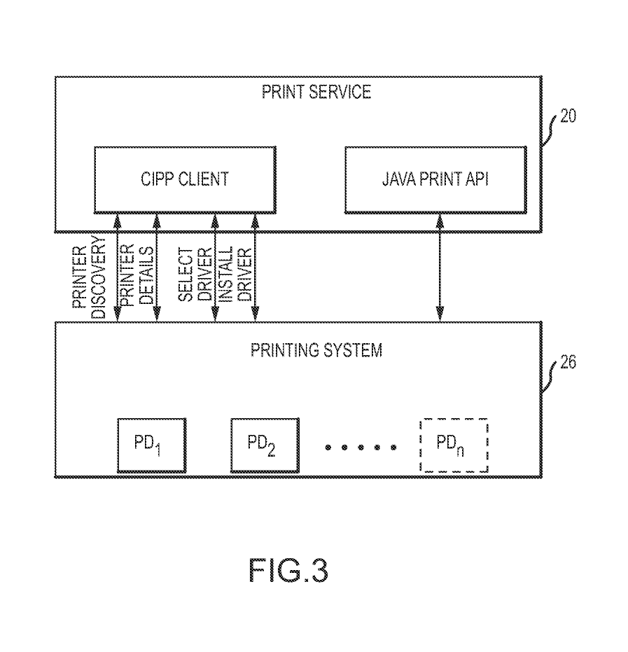

As disclosed herein, the device 12 differs from these previously-mentioned conventional devices in that it also includes a Print Service 20, a Printer Setup 24, and a Printing System 26. The Print Service 20 communicates with an Application 22 that may generate or obtain a file to be printed. As is shown in FIG. 3, the Print Service 20 includes a protocol (e.g., Internet Printing Protocol client (CIPP)) that commands the Printing System 26 to: (1) discover what printers are in the nearby vicinity of the device 12, (2) determine details about such nearby printers, (3) determine the printer driver required for communication with a particular printer, and (4) obtain and install said printer driver. As is known, the IPP is a network protocol primarily used for remote printing. In this case, it provides communication between the Print Service 20 and the Printing System 26. The Print Service 20 also communicates with the Printer Setup 24 which may include a Graphical User Interface (GUI) that enables the user to participate in the processes described in the previous sentence. The Print Service 20 also includes a suitable interface such as a Java Print API (Application Programming Interface) (e.g., the Java Harmony Print API) that sends the file to be printed to the Printing System 26. The Java Print API provides an interface between the Print Service 20 and the Printing System 26, the interface including multiple calling conventions that specify how data is to be transferred between component layers. The Printing System 26 uses the appropriate printer driver that corresponds to the printer to be used and creates a print job from the file to be printed that was sent by the Java Print API. This print job is then communicated to the wireless router 16 and routed to the printer 18, where it is printed.

Some of the system 10 described above will now be explored in further detail. The Print Service 20, Application 22, Printer Setup 24, and Printing System 26 may each include one or more software modules that reside on the device 12. These software modules may operate on one or more processors (e.g., processor 116) located in the device 12. Further, in one embodiment, these modules may operate on the Android operating system, although any other suitable operating system (OS) or Mobile OS could be used. The Print Service 20 may be custom-written Java software that is compiled separately from the Android operating system. As stated previously, the Print Service 20 includes the IPP client (CIPP) which allows the Print Service 20 to communicate via the Internet Printing Protocol with the Printing System 26. As can be appreciated, the Print Service 20 provides an interface and communication between the user-level Application 22 and all downstream components of the system 10.

The Printing System 26 may include the Common Unix Printing System (CUPS), which is open source software usable under the applicable GNU license, although other printing systems could also be used. CUPS includes a print spooler and scheduler, filters, as well as printer drivers. CUPS uses Internet Printing Protocol to manage print jobs and queues. As discussed previously, CUPS can access the internet and download any printer drivers that it needs for printing to a particular printer. Further, CUPS communicates with nearby printers, such as printer 18, through appropriate devices, such as router 16. CUPS uses IPP to communicate and do the functions like discovering what printers are nearby, discovering details about those printers, and determining what drivers are required. The IPP may communicate with the printer divers along port 631 in the conventional manner. CUPS is controlled through the CIPP in the Print Service 20 to perform certain of these functions. While CUPS has been referred to specifically herein, other printing systems could also be used such as Novell iPrint, printing systems available in Windows, or other printing systems, including a printing system that might be created from scratch for the device 12. The CIPP in the Print Service 20 is based on a portion of CUPS that has been modified in C and uses CUPS tools. The Application 22 can be any or a variety of different types of applications that a user may wish to run on the operating system of the device 12. Non-limiting examples may include web browsers, word processing programs, spreadsheet programs, presentation generating programs, email programs, image manipulation and processing programs, and the like. While there may be some applications that are not designed to interact with a print service, in such cases there are various workarounds to be able to print nonetheless. One example would be to use a screen capture application that can capture the current screen display and send it to the print service through the methods disclosed herein. Other applications may include a print service therein.

As is known, a printer driver is a limited program that translates a file to be printed into a file known as a print job that is interpretable by a corresponding printer. Printer drivers are unique to each printer and contain a description of the printer's capabilities and characteristics. This description is provided to the Printing System 26 and the Print Service 20. The Application 22 also communicates with the Print Service and the Printing System 26. Thus, the Print Service 20 and Printing System 26 act as an intermediary between the Application 22 and the printer driver. Further, since the Print Service 20 and Printing System 26 hide driver functionality from the Application 22, they act as an abstraction layer.

Printer variables such as portrait/landscape orientation, number of copies to be printed, and other variables can be set by the application or by some combination of the Print Service 20 and Printing System 26. Links between the Print Service 20 and Printing System 26 may be made at runtime rather than at compilation time. This can be done with dynamic linking, which can include modules that are compiled separately and possibly by different tools or compilers and then are linked at runtime. Dynamic linking can be contrasted with static linking, which includes separate modules that are compiled together to create one piece of machine code.

Some portion of the software modules described herein may be open source software subject to applicable licenses. For example, CUPS is open source. Further, the CIPP is derived from open source software. While these specific examples have been discussed herein, it would also be possible to use other software that has similar functionality and is not subject to open source restrictions. This other software could come from another source or it could be custom-written for the device 12.

As can be appreciated, the mobile printing framework disclosed herein allows a user of a mobile device to be able to discover and print to nearby printers. As mentioned previously, this may occur when a user is traveling away from their normal workplace or residence. Further, this framework does not require the advance loading of hundreds of printer drivers or the cumbersome moving of memory devices between computers to print to a nearby printer.

It is also noted that the Java that Google has placed onto Android has the Java Print API removed. Thus, it was not contemplated that the Java Print API would be necessary, required, or even helpful in portable devices that contain the Android operating system.

Any other combination of all the techniques discussed herein is also possible. The foregoing description has been presented for purposes of illustration and description. Furthermore, the description is not intended to limit the invention to the form disclosed herein. While a number of exemplary aspects and embodiments have been discussed above, those of skill in the art will recognize certain variations, modifications, permutations, additions, and sub-combinations thereof. It is therefore intended that the following appended claims and claims hereafter introduced are interpreted to include all such variations, modifications, permutations, additions, and sub-combinations as are within their true spirit and scope.

1. A system for sending print jobs to an external printer from a mobile telecommunication and computing device that can access both a telephone network and the internet, comprising:
one or more processors on the mobile telecommunication and computing device that contain at least the following processing modules thereon:
an application that contains or generates a file to be printed;
a print service that communicates with the application; and
a printing system that communicates with the print service, with external printers, and with the internet, wherein the printing system obtains printer drivers by accessing the internet;
wherein, upon request by the print service, the printing system discovers a printer connected to a local network associated with a nearby wireless router, and further, the printing system determines if the printing system already contains the necessary printer driver to send print jobs to that printer and obtains that printer driver via the internet if it is not already contained in the printing system, and uses that printer driver to create a print job from the file to be printed, and then the print job is sent to the printer.

2. A system as defined in claim 1, wherein the print service obtains the file to be printed from the application and supplies it to the printing system.

3. A system as defined in claim 2, wherein the print service includes a print API.

4. A system as defined in claim 1, wherein the print service controls the printing system to perform the functions of printer discovery, obtaining printer details, selecting the printer driver, and installing the printer driver.

5. A method implemented in a mobile telecommunication and computing device for sending print jobs to an external printer, the method comprising:
generating or obtaining a file to be printed;
determining what local computer networks are located in the vicinity of the device;
determining what type of printer is connected to that local network;
determining whether a printer driver for that type of printer currently is loaded onto the device;
if not currently loaded, obtaining the printer driver via the internet and loading it on the device;
using the printer driver to convert the file to be printed into a print job; and
sending the print job to the external printer via the local network.

6. A method as defined in claim 5, wherein the determining operations are each performed by a printing system.

7. A method as defined in claim 6, wherein the printing system is controlled by a print service.

8. A method as defined in claim 7, wherein the file to be printed is sent to the printing system via a print API that is contained in the print service.

9. A method as defined in claim 5, wherein the file to be printed is sent to the printing system via a print API.
